(19) United States
(12) Patent Application Publication
(10) Pub. No.: US 2006/0030953 A1
(43) Pub. Date: Feb. 9, 2006

(54) Remote monitoring of a hot melt adhesive system

(76) Inventors: Stephen Cantrell, Freemansburg, PA (US); Charles Saunders, Suwanee, GA (US); Kevin Dutton, Lawrenceville, GA (US)

Correspondence Address: CALFEE, HALTER & GRISWOLD, LLP, 800 SUPERIOR AVENUE, SUITE 1400, CLEVELAND, OH, 44114, US

(21) Appl. No.: 11/248,497

(22) Filed: Oct. 6, 2005

Related U.S. Application Data
(63) Continuation of application No. PCT/US04/35713, filed on Oct. 28, 2004.
(60) Provisional application No. 60/481,585, filed on Oct. 30, 2003.

(51) Int. Cl. G05B 11/01; G05B 15/00

(52) U.S. Cl. 700/17; 340/3.1; 700/283; 700/264

(57) ABSTRACT

Various embodiments of a system and related methods for wireless connection of a dispensing or spraying material application system to a network for remote operations are disclosed. One embodiment comprises a wireless access point wirelessly communicating with wireless communication links for application system monitoring modules.

### RELATED APPLICATION

This application claims the benefit of U.S. Provisional patent application Ser. No. 60/481,585 filed on Oct. 30, 2003, for REMOTE MONITORING OF A HOT MELT ADHESIVE SYSTEM, the entire disclosure of which is fully incorporated herein by reference.

### FIELD OF THE INVENTION

The invention relates generally to material dispensing and application systems. More particularly, the invention relates to monitoring and/or controlling such systems from remote locations such as a field site or a production/manufacturing site.

### BACKGROUND OF THE INVENTION

Material application systems may be broadly categorized as liquid or powder dispensing systems. Liquid dispensing systems may include, though not be limited to, adhesives, sealants, caulks, paint, adhesives, conformal coatings, lacquers, powder slurries and so forth. Powder dispensing systems may include powder paint coatings and other non-paint materials in powder form such as lubricants (for example, powdered graphite) and food additives such as flavorings and coatings for example; and powdered superabsorbants such as may be applied to diapers.

Application systems can be rather complex systems in terms of various control and safety functions. Such systems include an array of one or more dispensing guns or devices, pumps, material feed centers and overspray recovery systems. Some dispensing application systems include electrostatic spraying devices and most use pneumatic pressure as part of the application process. Many parameters may be monitored and adjusted including pressure of the liquid being dispensed, flow rates, temperature, electrostatic voltage and current, air pressure, material pressure, flow rates, gun position, pump flow rates and so forth. Also, material may be dispensed onto parts in a stationary condition or while moving via a conveyor system. Thus, an application system may include a number of sensors for position and speed control of the conveyor system, as well as sensors associated with triggering control of the dispensing devices.

Heretofore, the process of controlling and monitoring/maintaining material application systems has been accomplished by time consuming and personnel intensive processes. For example, a customer or purchaser might first visit the manufacturer's site to observe the different application systems available and witness various demonstrations. A system is then recommended based on the needs of the customer. The system is then installed and operated locally. If problems occur, typically a field service representative is then called out to the customer's site for troubleshooting and/or repair. Historical records of system performance and data histories, however, are typically site or customer specific, other than the possible feedback by the service representative to the manufacturing site.

The general and greatly simplified process described above is very time and labor intensive. Moreover, the process of detecting and/or predicting the need for repair and maintenance efforts often results in system downtime for the customer, which increases production time and cost.

The Internet and other information communication systems have greatly facilitated the ability of customers, for example, to study manufacturer's product and system offerings from the remote customer site. Catalog databases and online purchasing/ordering systems allow a customer to order parts directly from a desktop personal computer. Such catalog ordering systems have been commonly applied in many different product fields from the sales of books to purchasing cars and so forth. However, such known systems do not adequately address the problems associated with complex manufacturing systems, particularly material application systems. Many times a customer may have minimal support personnel at their site for monitoring system performance. Known Internet and Web based systems also do not facilitate repair and maintenance activities. Such systems typically require a hardwired connection between the controller of the application system and a network, which in turn connects to the Internet.

### SUMMARY OF THE PRESENT INVENTION

In accordance with one embodiment of the present invention, a system for monitoring and controlling a material dispensing system is provided. The system includes a user interface remotely located from the dispensing system, a communication network and a wireless network that connects the dispensing system to the communication network.

In accordance with another embodiment of the present invention, a method for monitoring and controlling a material dispensing system is provided. The method includes the steps of connecting a remote user to a communication network and wirelessly connecting the dispensing system to the communication network.

In accordance with another embodiment of the present invention, a system for monitoring a material dispensing system is provided. The system includes a dispensing system, a controller connectable to a wireless network, a communication network that is connectable to the wireless network and a remote user connectable to the communication network.

In accordance with another embodiment of the present invention, a system for monitoring a material dispensing system having a plurality of application system monitoring modules is provided. The system includes a wireless communication link for each module and a wireless access point wirelessly communicating with each module.

In accordance with another embodiment of the present invention, a system for monitoring a material dispensing system having a plurality of application system monitoring modules is provided. The system includes a web server and a wireless communication link for each module and a wireless access point wirelessly communicating with each module.

In accordance with another embodiment of the present invention, a system for remotely monitoring a material dispensing system is provided. The system includes an application system controller coupled to a web interface card adapted for communicating with an external network.

In accordance with another embodiment of the present invention, a system for monitoring a material dispensing system by a remote user is provided. The system includes at least one controller having a web server communicating with the remote user via the internet.

In accordance with another embodiment of the present invention, a method for remotely monitoring a material dispensing system is provided. The method includes the step of providing at least one web page on an external network created by a web server coupled to a controller, the web page containing at least one piece of information regarding the status of the customer.

### DESCRIPTION OF THE FIGURES

FIG. 1 is an exemplary system diagram of a system for remotely monitoring and controlling a material dispensing system.

FIG. 2 is an exemplary system diagram of various exemplary application monitor functions for a system for remotely monitoring and controlling a material dispensing system.

FIG. 3 is an exemplary system diagram of a system for remotely monitoring a material dispensing system.

### DETAILED DESCRIPTION OF PREFERRED AND ALTERNATE EMBODIMENTS

The following includes definitions of exemplary terms used throughout the disclosure. Both singular and plural forms of all terms fall within each meaning. Except where noted otherwise, capitalized and non-capitalized forms of all terms fall within each meaning:

As used herein, “logic” is used generically and includes but is not limited to hardware, software and/or combinations of both to perform a function.

As used herein, “software” is used generically and includes but is not limited to one or more computer executable instructions, routines, algorithms, modules or programs including separate applications or from dynamically linked libraries for performing functions as disclosed herein. Software may also be implemented in various forms such as a servlet, applet, stand-alone, plug-in or other type of application. Software can be maintained on various computer readable mediums as known in the art.

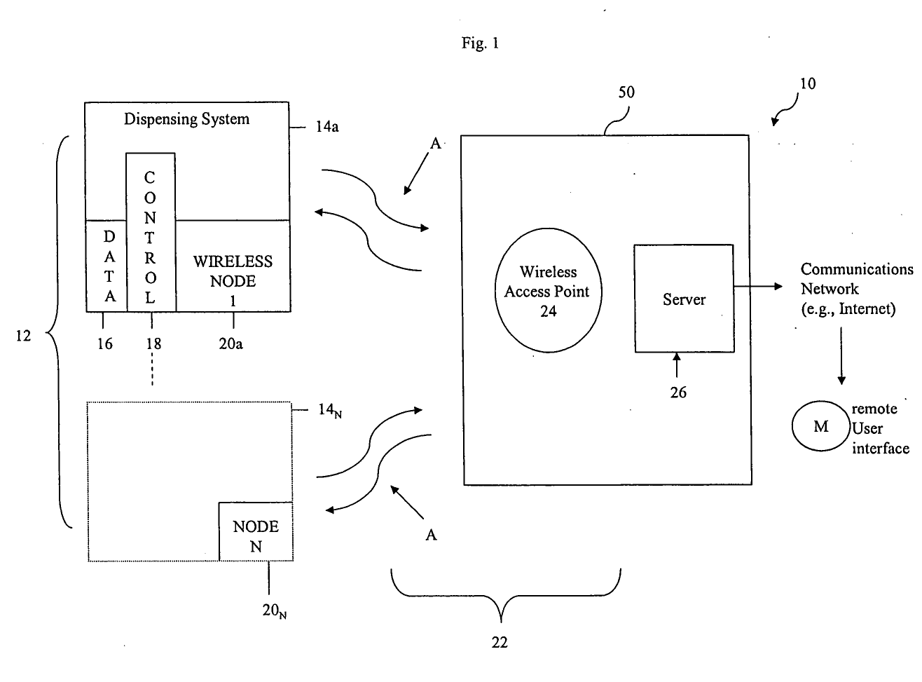

With reference to FIG. 1, the invention contemplates an information exchange system 10 that facilitates remote monitoring and control of a material application system 12 located at a customer production or usage site. Such production sites are typically geographically remote or distant from the manufacturing site of the manufacturer of the material application system. A customer may also have a number of production and support sites that are geographically remote from each other. A customer support site may include purchasing, production engineering and so forth. As used herein, however, the concept of “remote” access is not to be construed in terms of geographical distance, but more generally to the idea of providing access at a location that is separate from the site or locus of the material application system. For example, a remote location may be a different country, state, city, building or location within a building that contains the application system. Although the exemplary embodiments of the present invention are described in the context of an Internet based information exchange or network system, those skilled in the art will appreciate that the Internet is but one example of an open undedicated communication system or network that may be used to practice the present invention. Additionally, dedicated communication links via land wire and wireless modem connections, optical communication systems, satellite communications and so forth are just a few examples of data and information exchange communication systems that may also be used with the present invention. The Intemet, for example, provides the ability to access information across the open network from virtually any location in the world. By “open” it is simply meant ready access to the Internet via an Internet Service Provider (“ISP”) or via a server connected thereto, it being recognized that secure access is available through various data encryption and password control scenarios.

Furthermore, although the described embodiments herein are in the context of an exemplary liquid dispensing material application system, such description is intended to be illustrative in nature and should not be construed in a limiting sense. The present invention may be used in a wide variety of material application systems, including but not limited to adhesives, sealants, coatings, powder spraying systems and liquid spraying systems, and further may be used in connection with the application of material to a wide variety of articles such as but not limited to boxes, cartons, packages, car parts, electronic components, metal parts, non-metal parts, cans and other containers including biodegradable containers, and so forth. The foregoing is not intended to be an exhaustive list by any means and should not be construed in a limiting sense. Still further, although the described embodiments incorporate various aspects of the invention into a single system, such description is for convenience and ease of understanding and not intended to be limiting. The various aspects of the invention may be used individually or in any number of various combinations in a particular system based on the particular needs of the customer. The terms “customer” and “user” are used interchangeably herein and in a broad sense to identify anyone having access to the various features of the system. An exemplary liquid dispensing system having remote Internet access for control and monitoring functions with which the present invention may be used is described in U.S. patent application Publication No. US 2002/0198609A1 published on Dec. 26, 2002, the entire disclosure of which is fully incorporated herein by reference.

In FIG. 1 then, the system 10 includes a customer manufacturing or production site 12 that may include one or more dispensing systems or system requirements. The production site 12 may include one or more (up to N) application system monitoring modules 14a-14_{N}. Exemplary systems 14 include but are not limited to PROBLUE™, DURABLUE™ and VERSABLUE™ brand dispensing systems available from Nordson Corporation, Westlake, Ohio. The monitoring modules 14 are realized in a conventional manner using a number of sensors, gauges, detectors, controllers, actuators, valves, pumps and so forth. In this example, each application system 14 is treated as a node in that a separate controller is used in each application system 14 to control the operations thereof. However, the various systems 14 may also be interconnected or linked to a local primary control system (with possibly one or more local secondary controllers) such as a programmable logic controller (PLC) or other suitable control system at the customer's production facility 12. Alternatively for example a distributed embedded control system may be used. The monitoring modules 14 thus utilize a number of interactive system components that are provided by the manufacturer (“M”) or other supplier, for example, to permit local monitoring and control functions via a controller. Examples of such a local monitoring and control system is described in U.S. Pat. Nos. 6,132,511 and 5,167,714 the entire disclosures of which are fully incorporated herein by reference. Such patents may be referred to for details of a typical local control system but should not be construed as limiting of the present invention. Many types of local control systems are well known to those skilled in the art and a detailed description thereof herein is not necessary to the understanding and practice of the present invention. By “local” it is simply meant that the control and monitoring functions are implemented within the customer's site, but may include the feature of dedicated LAN and WAN systems and other dedicated closed networked systems within the production site 12 and possibly linked to other dedicated closed network systems of the customer.

Each application system 14 internally executes various control and monitoring functions as required by the customer, thereby generating data 16 and control functions 18. In accordance with one aspect of the invention, each material application system also serves as a node 20 (or a client) to a wireless network 22. Each node 20a through 20_{N} includes a wireless communication link A to an access point 24, which for example may be realized in the form of a wireless network router 24. Access point 24 is any suitable wireless device for facilitating wireless communication among and between nodes 20a through 20_{N}, including but not limited to a router, hub or a switch. Access point 24 is configured in any suitable number of devices to facilitate a communication among the nodes (e.g., multiple linked routers for a large number of nodes). Access point 24 provides any suitable services for facilitating wireless communication between the nodes, including but not limited to address direction and bandwith allocation. A significant advantage of this configuration is that the access point 24 is easily movable and positioned within the user's facility. For example, the access point 24 may be placed in a suitable cabinet or enclosure and placed at a location on the shop floor or on a wall or other support that allows the access point 24 to communicate wirelessly with each node 20. The access point 24 can easily then be removed for maintenance or moved to additional locations as the production site changes.

The particular wireless network 22 utilized will be selected based on the communication requirements of the customer. Any of a number of well known and commercially available systems may be used, including but not limited to BLUETOOTH™ wireless systems, Infrared (IrDA) systems, HomeRF (SWAP) systems, Wi-Fi (WECA) wireless networks, any IEEE802-11-compatible wireless systems, and any wireless system adapted for use with Palm™, Mac™, or IBM™-compatible computing devices. The selected wireless system 22 will be determined by the number of nodes that are to be interconnected and the speed of communication desired, as well as the communication needs back to the manufacturing site M. The manufacturing site M may alternatively be a product support site, a repair and maintenance facility and so on to name a few examples.

In accordance with another aspect of the invention, access point 24 additionally communicates with a customer-external communication network, such as for example the Internet. Internet access is achieved by any suitable mechanism, including, but not limited to, a T-3 line, a T-1 line, a modem, wireless internet, Ethernet, or any suitable Internet connection provided by an ISP. Nodes 20a through 20_{N} are thus accessible via the Internet directly, as, for example, via a peer-to-peer exchange. Nodes 20a through 20_{N} each have a static Internet Protocol (“IP”) address or optionally have dynamically-issued IP addresses (e.g., if access point 24 is a router or a hub plus a proxy server). Access point 24 optionally has a static IP address and optionally dynamically generates EP addresses for each node 20a through 20_{N}. It will be appreciated that each node 20a through 20_{N} is thus directly addressable on the Internet, whether directly via a static IP address or dynamically via an IP address generated by access point 24 (which optionally has its own static IP address) or upstream of the Internet connection by the ISP. Use of the Internet as part of a remote control and monitoring function is also described in published U.S. patent application US2002-0047051 published on Apr. 25, 2002, the entire disclosure of which is fully incorporated herein by reference, as well as the above referenced application publication. Reference may be made to these applications for exemplary concepts for remote monitoring and control, however, this is but one of many different examples and configurations that may be used. It will be appreciated that peer-to-peer communication between remote Internet user M and at least one node 20a through 20_{N} via wireless communication A is thus facilitated.

In accordance with another aspect of the invention, the access point 24 communicates with a web server 26 that is connectable to the Internet as is well known in the art. Server 26 and access point 24 communicate in any suitable manner. For example, access point 24 and server 26 may comprise system 50 which communicates via cables, wireless or other suitable connection (such as connecting a router as access point 24 to an Ethernet port in a personal computer as server 26). A suitable web server that can be utilized with the invention and is very small and easy to install is an iPic™ web server as designed by The University of Massachusetts. The web server may further be incorporated into the access point 24 as another alternative. Alternatively, Server 26 is incorporated with one or a plurality of systems 14. In this embodiment, each system 14a through 14n optionally has a Server 26. Each Server 26 is optionally incorporated with the wireless node 20 of each system 14. Each Server 26 and each wireless node 20 of each system 14 is optionally integrated into a single board which communicates with system 14. A suitable board combining both a Server 26 and a wireless node 20 is an AnyBus board available from HMS Industrial Networks. An AnyBus board generally includes an on-board microprocessor, dual port RAM, a cache of cyclic I/O data (e.g., 512 bytes), a mailbox interface (e.g., 2048 bytes) and a fieldbus interface which handles the fieldbus protocol separately and supports the protocol used by the controller of the dispensing system. The webserver on board the AnyBus generally supports SSI scripting for performing function calls for collecting data from the dual-port RAM and for presenting such data dynamically on a served web page while information is continually written to the dual port RAM from the controller. The webserver may also serve graphical information or any other information suitably served over the world wide web, including JAVA-based web pages and web page components. In embodiments of the present invention in which a Server 26 is installed in one or more systems 14, an additional Server 26 is not required at access point 24 or in system 50.

Server 26 and/or system 50 are optionally connected to the Internet or any suitable external communication network via access point 24 or any other suitable Internet connection mechanism. Server 26 creates at least one web page regarding systems 14a through 14_{N} and makes the page available via the Internet. The web page (or pages) optionally provides information regarding data 16 and/or control functions 18. The web page further facilitates receipt from a user M of information and/or command controls for systems 14a through 14_{N}. The Internet then provides a distributed open network that allows manufacturer representatives, technicians, engineers and so on to monitor operation of each application system 14 via web page interfaces. Optionally the application systems 14 may be controlled via this Internet link. Although the Internet is a preferred communication network, dedicated network communication systems may alternatively be used.

Server 26 may be realized based on a Windows™ style or other suitable platform (such as, e.g., a Palm™-based or Mac™-based platform) that provides data and other information that is accessible via a web site and web page links accessible through the Internet. A suitable server platform is the server platform used by the Anybus board. In this embodiment of the invention, a top level web site is a publicly accessible web site including one or more web pages maintained on Server 26 which is optionally under the control of the manufacturer M. Specific customer information and data available from Server 26 is optionally accessed only through a secure customer-specific web page link from the main page of the site server by Server 26 or is optionally a password protected site. Of course, a customer might not require a secure link but it is expected that in almost all cases a secure link will be used. A secure link may be realized, for example, by a required user name and password combination. Higher lever secure access features such as public and private key exchanges and so forth may be used as required. The web pages and sites may be implemented with conventional HTML language or other suitable software.

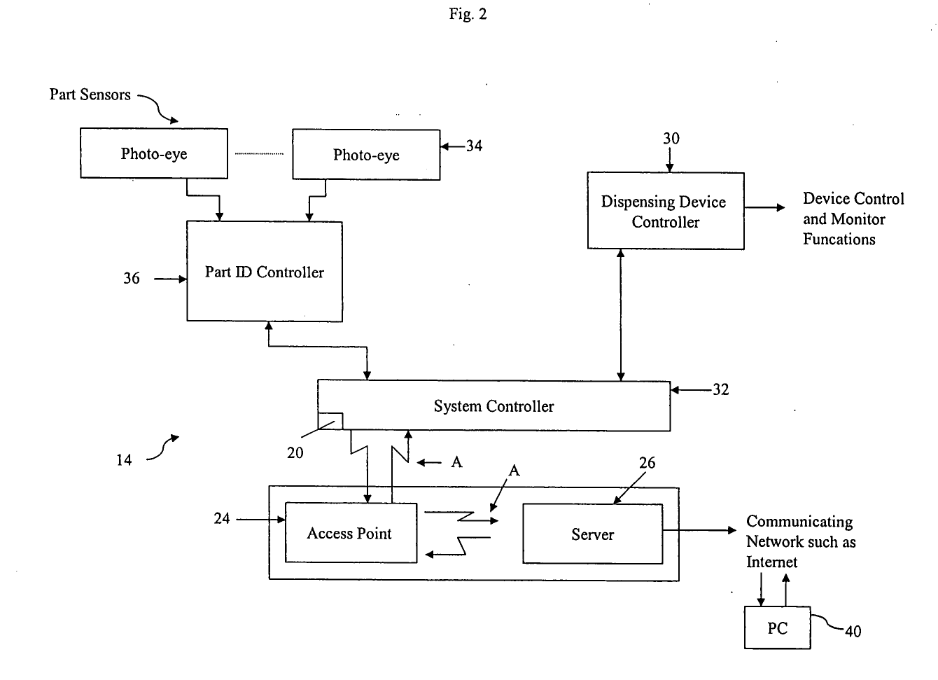

FIG. 2 illustrates an exemplary remote monitoring and control function that may be implemented with the present invention. The system allows a remote service technician, engineer or other authorized individual to collect data from one or more of the material application systems 14 and optionally send control commands thereto. In the example of FIG. 2, each application system 14 includes a local dispensing device controller 30 that may communicate with a system controller 32. The device controller 30 may alternatively be incorporated into the system controller 32. The local controller 30 and/or system controller 32 may also include control functions for conveyors, material supplies and so on. The system controller 32 may also receive one or more inputs from various sensors 34 as well as a part ID controller 36 for example. Any number of a wide variety of monitoring and control functions may be carried out with the present invention and the exemplary embodiments herein should not be construed in a limiting sense.

The system controller 32 includes the wireless node transmitter 20 which wirelessly communicates to the access point or router 24. The access point 24 further then communicates wirelessly with a web server 26 that is connectable to the Internet. Personnel connected-to the Internet may then use a personal computer 40 or other suitable interface device over the Internet to receive data and information from one or more of the application systems as part of a remote monitoring function, as well as send data and information including if desired control instructions to one or more of the application systems 14 as part of a remote control function. In this manner, remote wireless access is provided via the Internet directly to each application system 14. Alternatively, depending on the size of the production facility, various application systems 14 may be grouped together using additional control systems which in turn may be wirelessly linked to the Internet.

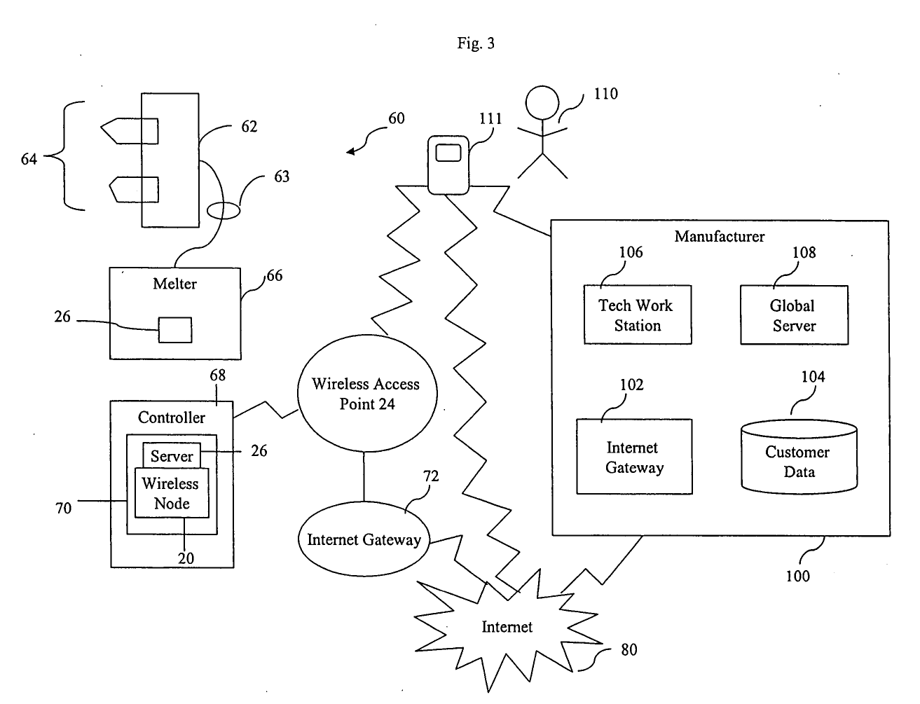

FIG. 3 illustrates an exemplary remote monitoring system of the present invention for a hot melt system. While FIG. 3 illustrates an embodiment of the present invention with a hot melt system, it will be understood that the exemplary illustrations herein are not limited to a hot melt system, but are applicable to any suitable material dispensing system, including but not limited to the material dispensing systems referenced herein.

An exemplary remote monitoring system for a hot melt system of FIG. 3 includes hot melt system 60 having a web interface card 70, wireless access point 24 and Internet connectivity. Hot melt system 60 includes one or more manifolds (or one or more service blocks) 62 having one or more dispensing guns 64, a melter 66 and a controller 68. Manifold 62 is connected to melter 64 by hose 63. Controller 68 is electrically connected to melter 66 by any suitable means, and may be integral therewith.

Controller 68 includes at least one web interface card 70. Web interface card 70 may optionally be integrated with melter 66. Web interface card 70 includes wireless node 20 and Server 26. The web interface card 70 optionally includes a wired node (not shown). A suitable web interface card is the AnyBus board described previously herein. Wireless node 20 is configured to wirelessly communicate with wireless access point 24 as described previously herein. The wireless access point 24 is connected to the Internet 80 (Internet connectivity) by any suitable means, including but not limited to an internet gateway 72.

Server 26 exchanges information with controller 68 regarding the hot melt system 60, optionally including information regarding the guns 64, the manifold 62 and the melter 66. Server 26 communicates with Internet 80 by sending and receiving transmissions to and from wireless access point 24. In an embodiment of the present invention, wireless access point 24 uses Internet gateway 72 to access Internet 80. Internet gateway 72 is any suitable access to the Internet, including but not limited to Internet access as described herein, such as a gateway via a T1 line.

While this embodiment is illustrated with regard to a single controller for a single hot melt system, it will be appreciated that multiple controllers for multiple hot melt systems can optionally implement the present invention. For example, a web access card can be included in each controller for each manifold for each hot melt system. In this exemplary embodiment, each manifold which has a controller has a Server 26 connected thereto and exchanging information therewith. In an additional example, each hot melt system has a controller which has a web access card. In this embodiment, each hot melt system has a Server 26 connected thereto and exchanging information therewith.

Wireless access point 24 is optionally configured to communicate with a plurality of web interface cards 70. In this exemplary embodiment, a plurality of controllers communicate via the wireless node 20 of each web interface card 70 associated with each controller with wireless access point 24. The number of controllers which communicate via wireless access point 24 may be increased or decreased within the capabilities of the wireless access point (e.g., if the wireless access point can facilitate communication with up to twelve wireless nodes, anywhere from one to 12 controllers may communicate via the wireless access point). The controllers may further be moved within the functional range of the wireless access point (e.g., if a wireless node/wireless access point combination has a taansmission range of 1000 feet, the nodes using this combination may be moved anywhere within a 1000 foot radius of the wireless access point). Wireless communication as described herein is optionally encrypted for safe transfer and/or to secure transmitted data. Any suitable encryption mechanism may be so used. For example, wherein wireless communication is facilitated by packet transfer(s), each packet is optionally encrypted. As such, data may be wirelessly communicated securely without use of a virtual private network or a dedicated connection.

Each Server 26 is capable of transmitting and receiving information regarding hot melt system 60 via the Internet by any suitable means, including but not limited to serving html pages containing such information and issuing one or more emails regarding such information. In an embodiment of the present invention, a manufacturer of the hot melt system 100 communicates with at least one hot melt system 60 via the Internet 80 via at least one Server 26.

Manufacturer 100 accesses the Internet by any suitable method, including but not limited to Internet gateway 100. Manufacturer optionally includes one or more technical workstations 106, one or more global servers 108, one or more customer databases 104 and optionally communicates with one or more field technicians 110. A technical workstation 106 is a computer, series of computers and/or a computer system configured to receive and/or transmit information to one or more Servers 26 of the hot melt system 60 via the Internet 80. A global server 108 is a computer, series of computers and/or a computer system configured to coordinate the manufacturer's 100 interaction with one or more Servers 26. A customer database 100 is any suitable database containing information relating to one or more hot melt systems accessible via one or more Servers 26. A field technician 100 is an expert charged with diagnosing and implementing technical fixes, updates, upgrades and/or other servicing of a hot melt system 60.

In an additional embodiment, system 60 is wirelessly accessed by hand-held computing device 111. Hand-held computing device is any portable computing device which is capable of wirelessly communicating with system 60, for example by wirelessly communicating with wireless access point 24, communicating with system 60 via an internet connection with the internet 80, or via communication with manufacturer 100. Suitable hand-held computing devices include, but are not limited to, “palm” computers or PDA's generally available from Palm, Hewlett Packard, Apple, etc. Such hand-held computing devices may optionally include wireless communication ability adapted to wirelessly communicate with, for example, the internet, a wireless access point 24 directly, or system 60 via a link with manufacturer 100. Such hand-held computing devices may also optionally include software and/or hardware adapted to communicate with a system 60. For example, an “off the shelf” hand-held device optionally includes software and/or hardware adapted to facilitate communication with system 60 via a wireless access point 24 or, optionally, with one or more wireless nodes 20. Hand-held device 111 may optionally be a proprietary portable computing device adapted for wireless communication with system 60.

Field technicians 110 are thus capable of wirelessly accessing system 60 “in the field” or in alternate locations (e.g., at manufacturer 100) via hand-held device 111. While this embodiment exemplifies communication between a field technician and a system 60 via a hand-held device 111, it will be appreciated that a field technician optionally accesses system 60 via any suitable connection, including but not limited to via a work station 106 or other suitable computing device. It will further be appreciated that any individual optionally accesses system 60 via a hand-held device 111. For example, a hand-held device is optionally used by a representative of a customer who uses system 60 (e.g., a customer technician) to wirelessly communicate with system 60. It will further be appreciated that hand-held device 111 is optionally adapted to wirelessly communicate with more than one entity. For example, a hand-held device 111 is adapted to wirelessly communicate directly with a wireless access point 24 and further adapted to wirelessly communicate with the Internet and/or a wireless communication network of manufacturer 100. A user of such a hand-held device optionally wirelessly communicates with both system 60 directly and manufacturer 100 directly (or via the Internet). Such a user optionally may both monitor/control system 60 and access the global server 108 and customer database 104 of manufacturer 100.

In an additional embodiment of the present invention, one or more hot melt systems 60 are connected and live at all times to the Internet 80 via one or more Servers 26 implemented in one or more web interface cards 70. For example, the Server 26 may receive information from the controller 68 regarding information relating to the operations of the hot melt system 60 and/or components thereof and post this information to the Internet via at least one served web page. Such information (also, operational events) include but is not limited to sensor information, temperature, pressure (including tank and/or nozzle), system settings, bead or disposition monitoring and accumulative cycles count as an indication of predicted failure. Such information is thus accessible by the customer, manufacturer and field engineer via any Internet connection.

In an additional example, Server 26 included alarm logic. Alarm logic includes any suitable steps, methods, processes and/or software for Server 26 to transmit a signal and/or other information in response to a triggering element. For example, upon a failure in an operational event or other triggering event (such as a timed milestone such as, e.g., maximum expected life), one or more Servers 26 can issue an alarm via the Internet by any suitable means, such as via an email or via a special posting to a served webpage. Such alarm may be received by any suitable monitoring personnel, such as, e.g., a field engineer or an employee of the manufacturer working at a technical work station 106 who is charged to look for such alarms. The alarm optionally includes diagnostic information to aid in the analysis of the reported instance. The monitoring personnel can contact the customer to alert regarding the instance. The monitoring personnel can also begin corrective action by any suitable method, including via an on-site trip by a field engineer or via transmission of operating parameters to Server 26 for download to controller 68 in order to change one or more operating parameters of the hot melt system 60. One or more customer databases 104 may be accessed to retrieve information regarding the hot melt system which is the subject of the alarm. Such information may assist in the analysis of the instance. Information regarding the alarm may further by stored in the customer database for future analysis.

Server 26 optionally includes email logic. Email logic includes any suitable steps, methods, processes and/or software for Server 26 to transmit one or more emails in response to the occurrence of one or more events. For example, the Server 26 is optionally configured with predefined email messages and programmed to send one or more of these messages upon the occurrence of one or more predefined events. For example, an AnyBus card facilitates storage of twenty predefined emails which can be sent from Server 26 of the AnyBus card. In an embodiment of the present invention, upon the occurrence of a pre-defined event, Server 26 sends a predefined email message to an appropriate recipient at the manufacturer 100 (e.g., a technical service representative at a technical work station 106). The recipient optionally forwards the email to another appropriate recipient, such as, e.g., a field engineer and/or the customer. The manufacturer recipient also optionally takes corrective action by transmitting information and/or commands to Server 26, by ordering parts or by scheduling on site repair.

In yet another example, Server 26 includes monitoring logic. Monitoring logic includes any suitable steps, methods, processes and/or software for monitoring system status and/or performing system quality checks. For example, continuous quality checks are optionally performed on all components of the hot melt system 63 via information provided by Server(s) 26. Information served by each Server 26 is monitored on a routine basis and all served information examined. Such monitoring is performed by any suitable entity, including but not limited to employees of the manufacturer 100 via technical work station(s) 106. For example, an employee accesses Server 26 information via the Internet 80 via a technical work station 106. In the event any system component or operational event appears to be outside the norm, corrections to the hot melt system may be made by the monitoring entity by any suitable means, including but not limited to uploading a software change to the Server 26, the controller 68 and/or any other software-controlled system element, ordering suitable replacement parts for repair, sending a field engineer or notifying the customer to take certain actions.

In yet another example, Server 26 includes web input logic. Web input logic includes any suitable steps, methods, processes and/or software for facilitating input from a remover user. For example, one or more Servers 26 are configured to contact one or more entities in the event of a predefined event, such as, e.g., an alarm or a downtime event. Such contact is effectuated by Server 26 in any suitable manner, including but not limited to by email, by voice mail and by phone call routed through manufacturer 100 to the customer.

In yet another example, one or more Servers 26 serve at least one web page including a web form for receiving information. A recipient of the web page with a web form, such as a manufacturer's technician at a technical work station 106, optionally enters information regarding hot melt system operation into the web form. Server 26 receives the entered information from the web form and modifies the hot melt system accordingly.

In another embodiment, a remote computer includes global review logic. Global review logic includes any suitable steps, methods, processes and/or software for accessing, storing and/or analyzing information retrieved from one or more Servers 26. In an exemplary embodiment, at least one global server 108 collects and analyzes information from one or more Servers 26. In this embodiment, a global server 108 is configured by manufacturer 100 to monitor one or more hot melt systems by remotely polling the Servers 26 associated with each such hot melt system. The global server 108 obtains information from Servers 26 by any suitable method, including but not limited to downloading one or more files relating to system operational information by using a standard httpget command. Global server 108 retrieves such information from a plurality of Servers 26 and optionally stores the retrieved information in at least one customer database 104. Global server 108 optionally analyzes the downloaded information on an individual system basis (i.e., by looking at information downloaded from each individual Server 26) and optionally on a multiple-system basis (i.e., by looking at information downloaded from multiple Servers 26) in order to obtain information regarding system activity, such as, e.g., determining “normal” levels of operation for a class of hot melt systems, identifying behavioral trends of systems and creating a maintenance history.

While the invention has been described with reference to a preferred embodiment, it should be understood by those skilled in the art that various changes may be made and equivalents may be substituted for elements thereof without departing from the scope of the invention. In addition, many modifications may be made to adapt a particular situation or material to the teachings of the invention without departing from the essential scope thereof.

Therefore, it is intended that invention not be limited to the particular embodiment disclosed as the best mode contemplated for carrying out this invention, but that the invention will include all embodiments falling within the scope of the appended claims.

Having thus described the invention, we claim:

1. A system for monitoring and controlling a material dispensing system, comprising:
a user interface remotely located from the dispensing system;
a communication network connectable to said interface; and
a wireless network that connects said dispensing system to said communication network.

2. The system of claim 1 wherein said interface device comprises a personal computer and said network comprises the Internet.

3. The system of claim 1 wherein said communication network comprises a web server and a secure Web site.

4. A method for monitoring and controlling a material dispensing system, comprising the steps of:
a. connecting a remote user to a communication network; and
b. wirelessly connecting the dispensing system to said communication network.

5. A system for monitoring a material dispensing system, comprising:
a dispensing system;
a controller for said dispensing system that is connectable to a wireless network;
a communication network that is connectable to said wireless network; and
a remote user connectable to said communication network.

6. The system of claim 5 wherein said dispensing system is accessible to said remote user via secure Web pages on the Internet.

7. The system of claim 1 wherein said wireless network comprises a wireless access point that can be positioned at a selectable location within a facility for communication with said dispensing system.

8. A system for monitoring a material dispensing system having a plurality of application system monitoring modules, comprising:
for each monitoring module, a wireless communication link; and
a wireless access point wirelessly communicating with each monitoring module.

9. The system of claim 8 wherein the wireless access point is at least one of the following:
(a) a wireless network router; and
(b) movable within a wireless communication range of the monitoring modules.

10. The system of claim 8, the wireless access point communicating with a customer-external communication network, and wherein each monitoring module is addressable over the customer-entered communication network from a remote site.

11. The system of claim 8, further including:
a web server communicating with the wireless access point and a customer-external communication network.

12. A system for monitoring a material dispensing system having a plurality of application system monitoring modules, comprising:
for each monitoring module, a web server and a wireless communication link; and
a wireless access point wirelessly communicating with each monitoring module.

13. The system of claim 12, the wireless access point communicating with a customer-external communication network, and wherein the wireless access point is a router and the customer-external communication network is the internet.

14. The system of claim 12 wherein the web server and the wireless communication link are integrated on a board coupled to the monitoring module.

15. The system of claim 12 wherein the web server is adapted for one or both (a) communicating with a monitoring module and (b) receiving data from a monitoring module.

16. The system of claim 15, the web server adapted for presenting the data on one or more web pages served by the web server.

17. The system of claim 12, the web server adapted for receiving information from a remote user.

18. The system of claim 17, the information including at least one command control, and the web server is adapted for communicating the command control to the monitoring module.

19. A system for remotely monitoring a material dispensing system, comprising:
an application system controller coupled to a web interface card, the web interface card adapted for communicating with a customer-external communication network.

20. The system of claim 19, the web interface card having a web server.

21. The system of claim 20, the web server performing at least one of the following:
(a) receiving information from the controller regarding the application system;
(b) transmitting control commands to the customer-external communication network; and
(c) communicating with the customer-external communication network.

22. The system of claim 19 further including a wireless access point for facilitating communication between the web interface card and the customer-external communication network.

23. The system of claim 22, the web interface card further including at least one of the following:
(a) a wireless communication link for wirelessly communicating with the wireless access point; and
(b) a web server.

24. A system for monitoring of a material dispensing system by a remote user, comprising:
at least one controller having a web server communicating with the remote user via the internet.

25. The system of claim 24 further including:
a wireless access point in communication with the internet; and
each controller further having a wireless node for communicating with the wireless access point.

26. The system of claim 25 wherein for each controller the web server and the wireless node are integrated on a single board coupled to the controller.

27. The system of claim 25 having a plurality of controllers, each having a web server and a wireless node in communication with the wireless access point.

28. The system of claim 24 wherein the web server is adapted to serve at least one web page to the internet, the web page containing information regarding the material dispensing system.

29. The system of claim 28, the served information including status information provided by the controller.

30. The system of claim 24 wherein the web server is adapted to transmit at least one email regarding the material dispensing system.

31. The system of claim 24, the web server including alarm logic for transmitting a signal over the internet in response to a triggering event.

32. The system of claim 31 wherein the signal is an email transmitted to the remote user, and wherein the email contains information regarding the triggering event.

33. The system of claim 24, the web server including email logic for transmitting one or more emails in response to one or more events.

34. The system of claim 33 wherein the web server has a plurality of pre-defined emails for transmission depending upon the nature of the event.

35. The system of claim 25 further including monitoring logic for monitoring system status.

36. The system of claim 25, the web server further including web input logic for inputting data to the web server.

37. The system of claim 36 wherein data input is at least one of the following:
(a) facilitated via a web form;
(b) including control commands; and
(c) including an update to the system.

38. The system of claim 25 further including:
a global server having global review logic for analyzing information received from one or more controllers.

39. The system of claim 38 further including a customer database for storing information regarding one or more controllers.

40. The system of claim 24 further including:
a hand-held computing device adapted to wirelessly communicate with the system.

41. A method for remotely monitoring a material dispensing system, comprising the steps of:
providing at least one web page on a customer-external communication network created by a web server coupled to a controller of the material dispensing system, the web page containing at least one piece of information regarding status of the controller.

42. The method of claim 41 further comprising:
wirelessly transmitting the webpage from the web server to a wireless access point which is in communication with the customer-external communication network.

43. The method of claim 41 further comprising:
storing the information in a remote database.
